(19) United States
(12) Patent Application Publication
(10) Pub. No.: US 2020/0372805 A1
(43) Pub. Date: Nov. 26, 2020

(54) APPARATUS AND METHOD OF CONTROLLING AUTONOMOUS PLATOONING OF ELECTRIC VEHICLE

(71) Applicants: HYUNDAI MOTOR COMPANY, Seoul (KR); KIA MOTORS CORPORATION, Seoul (KR)

(72) Inventor: Hyun Sup KIM, Gwangmyeong-si (KR)

(73) Assignees: HYUNDAI MOTOR COMPANY, Seoul (KR); KIA MOTORS CORPORATION, Seoul (KR)

(21) Appl. No.: 16/570,347

(22) Filed: Sep. 13, 2019

(30) Foreign Application Priority Data
May 23, 2019 (KR) 10-2019-0060582

(51) Int. Cl. G08G 1/00; B60L 58/12; G08G 1/0967; G05D 1/02; G05D 1/00; H04W 4/46

(52) U.S. Cl. CPC G08G 1/22; B60L 58/12; G08G 1/096791; G05D 2201/0213; G05D 1/0088; H04W 4/46; G05D 1/0293

(57) ABSTRACT

Disclosed are an apparatus and method of controlling autonomous platooning of an electric vehicle The apparatus includes a communication unit configured to communicate with a plurality of autonomous platooning vehicles, an index assignment unit configured to assign indexes to the plurality of autonomous platooning vehicles, a driving arrangement order determination unit configured to acquire battery information from the assigned autonomous platooning vehicles through the communication unit, and to determine a driving arrangement order of the assigned autonomous platooning vehicles based on the acquired battery information, and a controller configured to rearrange the plurality of autonomous platooning vehicles based on the determined driving arrangement order.

### CROSS-REFERENCE TO RELATED APPLICATION

The present application claims priority to and the benefit of Korean Patent Application No. 10-2019-0060582, filed on May 23, 2019, which is hereby incorporated by reference in its entirety.

### TECHNICAL FIELD

The present disclosure relates to an apparatus for controlling autonomous platooning of an electric vehicle, and more particularly, to an apparatus and method of controlling autonomous platooning of an electric vehicle, which maximizes a driving distance of an autonomous platooning electric vehicle.

### BACKGROUND

The statements in this section merely provide background information related to the present disclosure and may not constitute prior art.

In general, in future automobile technology, it is expected to be important to increase a driving distance and to develop autonomous driving technology for an electric vehicle (EV).

HW/SW technologies for increasing a driving distance of an electric vehicle (EV) are being developed, and the proliferation of future electric vehicles will be further enlarged.

Automobile OEMs and IT companies are also developing autonomous driving technologies and are planning to launch fully autonomous driving technologies on the market in the 2020's.

As such, by virtue of development of the autonomous driving technology and the introduction of fully autonomous driving technology, autonomous platooning control for simultaneously controlling two or more vehicles is possible.

However, when appropriate platooning control technology for an autonomous platooning vehicle is not applied, there is a problem in that a battery of a lead vehicle positioned at a frontmost position of a group is depleted most rapidly among all vehicles because the lead vehicle encounters the greatest air resistance, and even if other vehicles are capable of being driven further, a driving distance of the entire group is reduced due to the lead vehicle.

Accordingly, in the future, an apparatus for controlling autonomous platooning for improving a driving distance of the entire group of autonomous platooning electric vehicles may be desired.

### SUMMARY

The present disclosure provides an apparatus and method of controlling autonomous platooning of an electric vehicle.

One aspect of the present disclosure is to provide an apparatus and method of controlling autonomous platooning of an electric vehicle, which acquires battery information and vehicle information from autonomous platooning vehicles, determines a driving arrangement order based on the acquired information, and rearranges autonomous platooning vehicles according to the determined driving arrangement order, thereby maximizing the driving distance of the entire group.

In some forms of the present disclosure, an apparatus for controlling autonomous platooning of an electric vehicle includes a communication unit configured to communicate with a plurality of autonomous platooning vehicles, an index assignment unit configured to assign respective indexes to the autonomous platooning vehicles, a driving arrangement order determination unit configured to acquire battery information from the vehicles to which the indexes are assigned, through the communication unit, and to determine a driving arrangement order of the autonomous platooning vehicles based on the acquired battery information, and a controller configured to control the vehicles through the communication unit to rearrange the autonomous platooning vehicles according to the determined driving arrangement order.

In some forms of the present disclosure, a method of controlling autonomous platooning of an apparatus for controlling autonomous platooning of an electric vehicle including an index assignment unit, a driving arrangement order determination unit, and a controller includes, upon receiving an autonomous platooning control request signal, assigning respective indexes to autonomous platooning vehicles, by the index assignment unit, acquiring battery information from the vehicles to which the indexes are assigned, and determining a driving arrangement order of the autonomous platooning vehicles based on the acquired battery information, by the driving arrangement order determination unit, and controlling the vehicles to rearrange the autonomous platooning vehicles according to the determined driving arrangement order, by the controller.

In some forms of the present disclosure, a method of controlling autonomous platooning of an apparatus for controlling autonomous platooning of an electric vehicle including an index assignment unit, a driving arrangement order determination unit, and a controller includes, upon receiving an autonomous platooning control request signal, assigning respective indexes to autonomous platooning vehicles, by the index assignment unit, acquiring battery information from the vehicles to which the indexes are assigned, and calculating respective battery state-of-charge (SoC) values of the autonomous platooning vehicles based on the acquired battery information, by the driving arrangement order determination unit, calculating a difference value between a first battery SoC value of a following vehicle having a maximum battery SoC value and a second battery SoC value of a lead vehicle among the autonomous platooning vehicles, by the driving arrangement order determination unit, checking whether the calculated difference value is greater than a threshold value, by the driving arrangement order determination unit, when the calculated difference value is greater than the threshold value, determining the driving arrangement order to arrange the following vehicle having the maximum battery SoC value at a frontmost position of the autonomous platooning vehicles, by the driving arrangement order determination unit, and controlling the vehicles to rearrange the autonomous platooning vehicles according to the determined driving arrangement order, by the controller.

In some forms of the present disclosure, a method of controlling autonomous platooning of an apparatus for controlling autonomous platooning of an electric vehicle including an index assignment unit, a driving arrangement order determination unit, and a controller includes, upon receiving an autonomous platooning control request signal, assigning respective indexes to autonomous platooning vehicles, by the index assignment unit, acquiring battery information from the vehicles to which the indexes are assigned, and calculating respective battery energy amounts of the autonomous platooning vehicles based on the acquired battery information, by the driving arrangement order determination unit, calculating a difference value between a first battery energy amount of a following vehicle having a maximum battery energy amount and a second battery energy amount of a lead vehicle among the autonomous platooning vehicles, by the driving arrangement order determination unit, checking whether the calculated difference value is greater than a threshold value, by the driving arrangement order determination unit, when the calculated difference value is greater than the threshold value, determining the driving arrangement order to arrange the following vehicle having the maximum battery energy amount at a frontmost position of the autonomous platooning vehicles, by the driving arrangement order determination unit, and controlling the vehicles to rearrange the autonomous platooning vehicles according to the determined driving arrangement order, by the controller.

In some forms of the present disclosure, a method of controlling autonomous platooning of an apparatus for controlling autonomous platooning of an electric vehicle including an index assignment unit, a driving arrangement order determination unit, and a controller includes, upon receiving an autonomous platooning control request signal, assigning respective indexes to autonomous platooning vehicles, by the index assignment unit, acquiring battery information and vehicle information from the vehicles to which the indexes are assigned, and estimating respective driving distances of the autonomous platooning vehicles based on the acquired battery information and vehicle information, by the driving arrangement order determination unit, calculating a difference value between a first driving distance of a following vehicle having a maximum driving distance and a second driving distance of a lead vehicle among the autonomous platooning vehicles, by the driving arrangement order determination unit, checking whether the calculated difference value is greater than a threshold value, by the driving arrangement order determination unit, when the calculated difference value is greater than the threshold value, determining a driving arrangement order to arrange the following vehicle having the maximum driving distance at a frontmost position of the autonomous platooning vehicles, by the driving arrangement order determination unit, and controlling the vehicles to rearrange the autonomous platooning vehicles according to the determined driving arrangement order, by the controller.

In some forms of the present disclosure, a method of controlling autonomous platooning of an apparatus for controlling autonomous platooning of an electric vehicle including an index assignment unit, a driving arrangement order determination unit, and a controller includes, upon receiving an autonomous platooning control request signal, assigning respective indexes to autonomous platooning vehicles, by the index assignment unit, acquiring battery information and vehicle information from the vehicles to which the indexes are assigned, and estimating respective driving distances of the autonomous platooning vehicles based on the acquired battery information and vehicle information, by the driving arrangement order determination unit, calculating the number of cases of arrangement of platooning vehicles based on the estimated driving distances, by the driving arrangement order determination unit, determining a minimum driving distance in each case of arrangement of the platooning vehicles, by the driving arrangement order determination unit, selecting a case having the longest minimum driving distance among cases having the determined minimum driving distances, as a new case, by the driving arrangement order determination unit, checking whether a difference value between a maximum driving distance in the new case and a maximum driving distance in the current case is greater than a threshold value, by the driving arrangement order determination unit, when the difference value is greater than the threshold value, determining the driving arrangement order according to arrangement of platooning vehicles, which corresponds to the new case, by the driving arrangement order determination unit, and controlling the vehicles to rearrange the autonomous platooning vehicles according to the determined driving arrangement order, by the controller.

In some forms of the present disclosure, a computer readable recording medium having recorded thereon a program for executing a method of controlling autonomous platooning of an apparatus for controlling autonomous platooning of an electric vehicle may perform procedures provided by the autonomous platooning control method.

In some forms of the present disclosure, a server for controlling autonomous platooning includes a database configured to store battery information and vehicle information of a plurality of autonomous platooning vehicles, and an autonomous platooning control apparatus configured to determine a driving arrangement order of the autonomous platooning vehicles based on the battery information and the vehicle information and to control vehicles to rearrange the autonomous platooning vehicles according to the determined driving arrangement order, wherein the autonomous platooning control apparatus includes a communication unit configured to communicate with the plurality of autonomous platooning vehicles, an index assignment unit configured to assign respective indexes to the autonomous platooning vehicles, a driving arrangement order determination unit configured to acquire battery information from the vehicles to which the indexes are assigned, through the communication unit, and to determine a driving arrangement order of the autonomous platooning vehicles based on the acquired battery information, and a controller configured to control the vehicles through the communication unit to rearrange the autonomous platooning vehicles according to the determined driving arrangement order.

In some forms of the present disclosure, an electric vehicle includes a storage apparatus configured to store battery information and vehicle information of a plurality of autonomous platooning vehicles, and an autonomous platooning control apparatus configured to determine a driving arrangement order of the autonomous platooning vehicles based on the battery information and the vehicle information and to control vehicles to rearrange the autonomous platooning vehicles according to the determined driving arrangement order, wherein the autonomous platooning control apparatus includes a communication unit configured to communicate with the plurality of autonomous platooning vehicles, an index assignment unit configured to assign respective indexes to the autonomous platooning vehicles, a driving arrangement order determination unit configured to acquire battery information from the vehicles to which the indexes are assigned, through the communication unit, and to determine a driving arrangement order of the autonomous platooning vehicles based on the acquired battery information, and a controller configured to control the vehicles through the communication unit to rearrange the autonomous platooning vehicles according to the determined driving arrangement order.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a conceptual diagram for explanation of an apparatus for controlling autonomous platooning of an electric vehicle in one form of the present disclosure;

FIG. 2 is a block diagram for explanation of an apparatus for controlling autonomous platooning of an electric vehicle in one form of the present disclosure;

FIG. 3 is a diagram for explanation of a server for controlling autonomous platooning including an apparatus for controlling autonomous platooning of an electric vehicle in one form of the present disclosure;

FIG. 4 is a diagram for explanation of an electric vehicle including an apparatus for controlling autonomous platooning of an electric vehicle in one form of the present disclosure;

FIG. 5 is a flowchart for explanation of a method of controlling autonomous platooning in one form of the present disclosure;

FIG. 6 is a diagram for explanation of a vehicle rearrangement procedure of the method of controlling autonomous platooning of FIG. 5;

FIG. 7 is a flowchart for explanation of a method of controlling autonomous platooning in one form of the present disclosure;

FIG. 8 is a diagram for explanation of a vehicle rearrangement procedure of the method of controlling autonomous platooning of FIG. 7;

FIG. 9 is a flowchart for explanation of a method of controlling autonomous platooning in one form of the present disclosure;

FIG. 10 is a diagram for explanation of a vehicle rearrangement procedure of the method of controlling autonomous platooning of FIG. 9;

FIG. 11 is a flowchart for explanation of a method of controlling autonomous platooning in one form of the present disclosure; and

FIGS. 12 to 16 are diagrams for explanation of a vehicle rearrangement procedure of the method of controlling autonomous platooning of FIG. 11.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout the specification, one of ordinary skill would understand terms “include”, “comprise”, and “have” to be interpreted by default as inclusive or open rather than exclusive or closed unless expressly defined to the contrary. Further, terms such as “unit”, “module”, etc. disclosed in the specification average units for processing at least one function or operation, which may be implemented by hardware, software, or a combination thereof.

Throughout the specification, when a certain part “includes” a certain component, this indicates that the part may further include another component instead of excluding another component unless there is no different disclosure. The same reference numbers will be used throughout the drawings to refer to the same parts.

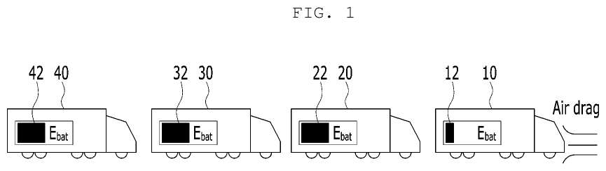

Hereinafter, an apparatus and method of controlling autonomous platooning of an electric vehicle in some forms of the present disclosure will be described in detail with reference to FIGS. 1 to 16.

FIG. 1 is a conceptual diagram for explanation of an apparatus for controlling autonomous platooning of an electric vehicle in some forms of the present disclosure.

As shown in FIG. 1, the present disclosure relates to a method for maximizing a driving distance of the entire group when fully autonomous driving technology and V2V communication are introduced to enable platooning control of an electric vehicle (EV).

When appropriate platooning control technology is not applied during autonomous platooning of an electric vehicle, a lead vehicle 10 positioned at a frontmost position of the group may encounter the greatest air resistance, and thus a battery 12 of the lead vehicle may be depleted most rapidly among all vehicles.

Accordingly, even if following vehicles 20, 30, and 40 other than the lead vehicle 10 are capable of being driven further, a driving distance of the entire group may be reduced due to the lead vehicle 10.

The present disclosure broadly proposes four platooning control methods.

A first control method is a strategic method of balancing a battery state-of-charge (SoC) between vehicles, a second control method is a strategic method of balancing battery energy between vehicles, a third control method is a strategic method of increasing a platooning distance, and a fourth control method is a strategic method of maximizing a platooning distance.

That is, the first, second, and third methods are methods for exchanging positions of a lead vehicle and one of following vehicles, and the fourth method is a method for changing a position of all vehicles for maximizing a driving distance.

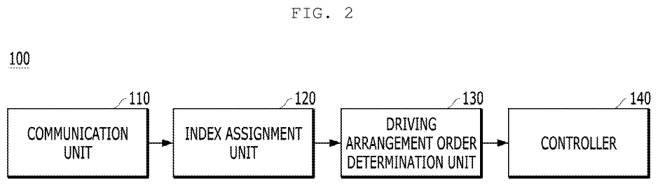

FIG. 2 is a block diagram for explanation of an apparatus for controlling autonomous platooning of an electric vehicle in some forms of the present disclosure.

As shown in FIG. 2, an apparatus 100 for controlling autonomous platooning of an electric vehicle in some forms of the present disclosure may include a communication unit 110 configured to communicate with a plurality of autonomous platooning vehicles, an index assignment unit 120 configured to assign an index to each autonomous platooning vehicle, a driving arrangement order determination unit 130 configured to acquire battery information from a vehicle to which an index is assigned through the communication unit 110 and to determine a driving arrangement order of the autonomous platooning vehicle based on the acquired battery information, and a controller 140 configured to control vehicles to rearrange the autonomous platooning vehicles according to the determined driving arrangement order through the communication unit 110.

Here, when assigning an index to each vehicle, the index assignment unit 120 may recognize the total number of all autonomous platooning vehicles and may assign indexes to respective vehicles and respective positions from all of the recognized vehicles.

For example, when assigning an index, the index assignment unit 120 may assign a first index to each of all of the autonomous platooning vehicles and may assign a second index corresponding to a position to each vehicle to which the first index is assigned.

When acquiring battery information from the vehicle to which the index is assigned, the driving arrangement order determination unit 130 may acquire the battery information including at least one of battery SoC information or battery energy amplitude information.

When acquiring the battery information from the vehicle to which the index is assigned, the driving arrangement order determination unit 130 may further acquire vehicle information.

That is, when further acquiring the vehicle information to which the index is assigned, the driving arrangement order determination unit 130 may check whether battery energy amount information is included in the acquired battery information, and when the battery energy amount information is included in the acquired battery information, the driving arrangement order determination unit 130 may further acquire the vehicle information.

For example, the vehicle information may include at least one of battery capacity, a battery deterioration degree, and a battery SoC of the vehicle to which the index is assigned, the weight of the vehicle to which the index is assigned, air resistance force, a slope, or drag, but is not limited thereto.

Then, when determining the driving arrangement order of autonomous platooning vehicles, the driving arrangement order determination unit 130 may calculate respective battery SoC values of autonomous platooning vehicles based on the acquired battery information and may determine the driving arrangement order to arrange a vehicle having a maximum battery SoC value at a frontmost position of the group of the autonomous platooning vehicles.

The driving arrangement order determination unit 130 may calculate a difference value between a first battery SoC value of a following vehicle having a maximum battery SoC value and a second battery SoC value of a lead vehicle among the autonomous platooning vehicles, and may check whether the calculated difference value is greater than a threshold value, and when the calculated difference value is greater than the threshold value, the driving arrangement order determination unit 130 may determine the driving arrangement order to arrange the following vehicle having the maximum battery SoC at a frontmost position of the group.

Here, when the driving arrangement order determination unit 130 determines the driving arrangement order, if the following vehicle having the maximum battery SoC value is arranged at a frontmost position of the group, the driving arrangement order determination unit 130 may determine the driving arrangement order to arrange an original lead vehicle adjacent to and immediately behind the following vehicle having the maximum battery SoC value.

When the driving arrangement order determination unit 130 determines the driving arrangement order, if the following vehicle having the maximum battery SoC value is arranged at a frontmost position of the group, the driving arrangement order determination unit 130 may determine the driving arrangement order so as to change an arrangement order of at least one following vehicle arranged between a rear side of the lead vehicle and a front side of the following vehicle having the maximum battery SoC value according to the original driving arrangement order.

When the driving arrangement order determination unit 130 determines the driving arrangement order, if the following vehicle having the maximum battery SoC value is arranged at a frontmost position of the group, the driving arrangement order determination unit 130 may determine the driving arrangement order to maintain an arrangement order of at least one following vehicle arranged behind the following vehicle having the maximum battery SoC value according to the original driving arrangement order without change.

Depending on the cases, when determining the driving arrangement order of the autonomous platooning vehicles, the driving arrangement order determination unit 130 may calculate respective battery energy amounts of the autonomous platooning vehicles based on the acquired battery information, and may also determine the driving arrangement order to arrange a vehicle having a maximum battery energy amount among the autonomous platooning vehicles at a frontmost position of the group.

The driving arrangement order determination unit 130 may calculate a difference value between a first battery energy amount of the following vehicle having the maximum battery energy amount and a second battery energy amount of the lead vehicle among the autonomous platooning vehicles, and may check whether the calculated difference value is greater than the threshold value, and when the calculated difference value is greater than the threshold value, the driving arrangement order determination unit 130 may determine the driving arrangement order to arrange the following vehicle having the maximum battery energy amount at a frontmost position of the group.

Here, when the driving arrangement order determination unit 130 determines the driving arrangement order, if the following vehicle having the maximum battery energy amount is arranged at a frontmost position of the group, the driving arrangement order determination unit 130 may determine the driving arrangement order to arrange an original lead vehicle adjacent to and immediately behind the following vehicle having the maximum battery energy amount.

When the driving arrangement order determination unit 130 determines the driving arrangement order, if the following vehicle having the maximum battery energy amount is arranged at a frontmost position of the group, the driving arrangement order determination unit 130 may determine the driving arrangement order so as to change an arrangement order of at least one following vehicle arranged between a rear side of the lead vehicle and a front side of the following vehicle having the maximum battery energy amount according to the original driving arrangement order.

When the driving arrangement order determination unit 130 determines the driving arrangement order, if the following vehicle having the maximum battery energy amount is arranged at a frontmost position of the group, the driving arrangement order determination unit 130 may determine the driving arrangement order to maintain an arrangement order of at least one following vehicle arranged behind the following vehicle having the maximum battery energy amount according to the original driving arrangement order without change.

In another case, when determining the driving arrangement order of the autonomous platooning vehicles, the driving arrangement order determination unit 130 may estimate respective driving distances of the autonomous platooning vehicles based on the acquired battery information and vehicle information and may determine the driving arrangement order to arrange a vehicle having a maximum driving distance among the autonomous platooning vehicles at a frontmost position of the group.

For example, the battery information may be a battery energy amount, and the vehicle information may include at least one of battery capacity, a battery deterioration degree, and a battery SoC of the vehicle to which the index is assigned, the weight of the vehicle to which the index is assigned, air resistance force, a slope, or drag, but is not limited thereto.

The driving arrangement order determination unit 130 may calculate a difference value between a first driving distance of a following vehicle having a maximum driving distance and a second driving distance of a lead vehicle among the autonomous platooning vehicles, and may check whether the calculated difference value is greater than a threshold value, and when the calculated difference value is greater than the threshold value, the driving arrangement order determination unit 130 may determine the driving arrangement order to arrange the following vehicle having the maximum driving distance at a frontmost position of the group.

Here, when the driving arrangement order determination unit 130 determines the driving arrangement order, if the following vehicle having the maximum driving distance is arranged at a frontmost position of the group, the driving arrangement order determination unit 130 may determine the driving arrangement order to arrange an original lead vehicle adjacent to and immediately behind the following vehicle having the maximum driving distance.

When the driving arrangement order determination unit 130 determines the driving arrangement order, if the following vehicle having the maximum driving distance is arranged at a frontmost position of the group, the driving arrangement order determination unit 130 may determine the driving arrangement order so asdrag, but to change an arrangement order of at least one following vehicle arranged between a rear side of the lead vehicle and a front side of the following vehicle having the maximum driving distance according to the original driving arrangement order.

When the driving arrangement order determination unit 130 determines the driving arrangement order, if the following vehicle having the maximum driving distance is arranged at a frontmost position of the group, the driving arrangement order determination unit 130 may determine the driving arrangement order to maintain an arrangement order of at least one following vehicle arranged behind the following vehicle having the maximum driving distance according to the original driving arrangement order without change.

In another case, when determining the driving arrangement order of the autonomous platooning vehicles, the driving arrangement order determination unit 130 may estimate respective driving distances of the autonomous platooning vehicles based on the acquired battery information and vehicle information, may calculate the number of cases of arrangement of platooning vehicles based on the estimated driving distance, may determine minimum driving distances for the respective cases of arrangement of platooning vehicles, may select, as a new case, a case having the longest minimum driving distance among cases having the determined minimum driving distances, and may determine a driving arrangement order according to arrangement of platooning vehicles, which corresponds to the new case.

When determining the driving arrangement order of the autonomous platooning vehicles, the driving arrangement order determination unit 130 may estimate respective driving distances of the autonomous platooning vehicles based on the acquired battery information and vehicle information, may calculate the number of cases of arrangement of platooning vehicles based on the estimated driving distance, may determine minimum driving distances for the respective cases of arrangement of platooning vehicles, may select, as a new case, a case having the longest minimum driving distance among cases having the determined minimum driving distances, and may check whether a difference value between a maximum driving distance in the new case and a maximum driving distance in the current case is greater than a threshold value, and when the difference value is greater than the threshold value, the driving arrangement order determination unit 130 may determine a driving arrangement order according to arrangement of platooning vehicles, which corresponds to the new case.

For example, the battery information may be a battery energy amount, and the vehicle information may include at least one of battery capacity, a battery deterioration degree, and a battery SoC of the vehicle to which the index is assigned, the weight of the vehicle to which the index is assigned, air resistance force, a slope, or drag, but is not limited thereto.

Each case of arrangement of platooning vehicles may include a driving arrangement order of autonomous platooning vehicles and a driving distance of each vehicle.

As such, in some forms of the present disclosure, the battery information and the vehicle information may be acquired from the autonomous platooning vehicles, a driving arrangement order may be determined based on the acquired information, and the autonomous platooning vehicles may be rearranged according to the determined driving arrangement order, thereby maximizing the driving distance of the entire group.

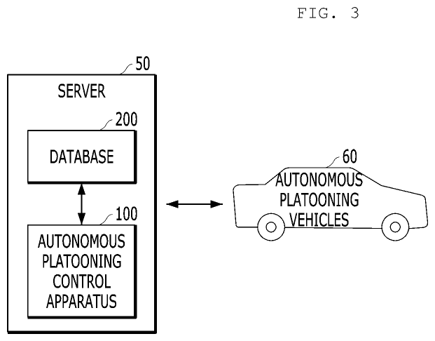

FIG. 3 is a diagram for explanation of a server for controlling autonomous platooning including an apparatus for controlling autonomous platooning of an electric vehicle in some forms of the present disclosure.

As shown in FIG. 3, the apparatus for controlling autonomous platooning of an electric vehicle in some forms of the present disclosure may also be applied to the server 50 for controlling autonomous platooning.

That is, the server 50 for controlling autonomous platooning may communicate with a plurality of autonomous platooning vehicles 60, may determine a driving arrangement order based on battery information and vehicle information of the vehicles 60, and may control vehicles to rearrange the autonomous platooning vehicles.

The server 50 for controlling autonomous platooning may include a database 200 configured to store battery information and vehicle information of the plurality of autonomous platooning vehicles, and the autonomous platooning control apparatus 100 configured to determine the driving arrangement order of the autonomous platooning vehicles based on the battery information and the vehicle information and to control the vehicles to rearrange the autonomous platooning vehicles according to the determined driving arrangement order.

Here, the autonomous platooning control apparatus 100 may include a communication unit configured to communicate with the plurality of autonomous platooning vehicles 60, an index assignment unit configured to assign an index to each autonomous platooning vehicle, a driving arrangement order determination unit configured to acquire battery information from a vehicle to which an index is assigned through the communication unit and to determine a driving arrangement order of the autonomous platooning vehicle based on the acquired battery information, and a controller configured to control vehicles to rearrange the autonomous platooning vehicles according to the determined driving arrangement order through the communication unit.

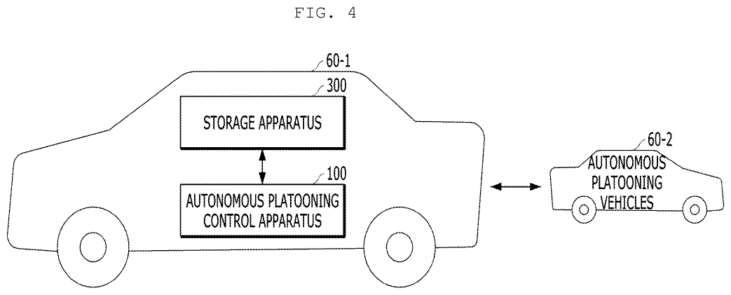

FIG. 4 is a diagram for explanation of an electric vehicle including an apparatus for controlling autonomous platooning of an electric vehicle in some forms of the present disclosure.

As shown in FIG. 4, the apparatus for controlling autonomous platooning of an electric vehicle in some forms of the present disclosure may also be applied to an autonomous platooning electric vehicle 60-1.

That is, the electric vehicle 60-1 may communicate with a plurality of autonomous platooning vehicles 60-2, may determine a driving arrangement order based on battery information and vehicle information of the autonomous platooning vehicles 60-2, and may control vehicles to rearrange the autonomous platooning vehicles.

The electric vehicle 60-1 may include a storage apparatus 300 configured to store battery information and vehicle information of a plurality of autonomous platooning vehicles, and the autonomous platooning control apparatus 100 configured to determine an driving arrangement order of the autonomous platooning vehicles based on the battery information and the vehicle information and to control vehicles to rearrange the autonomous platooning vehicles according to the determined driving arrangement order.

Here, the autonomous platooning control apparatus 100 may include a communication unit configured to communicate with the plurality of autonomous platooning vehicles 60-2, an index assignment unit configured to assign an index to each autonomous platooning vehicle, a driving arrangement order determination unit configured to acquire battery information from a vehicle to which an index is assigned through the communication unit and to determine a driving arrangement order of the autonomous platooning vehicle based on the acquired battery information, and a controller configured to control vehicles to rearrange the autonomous platooning vehicles according to the determined driving arrangement order through the communication unit.

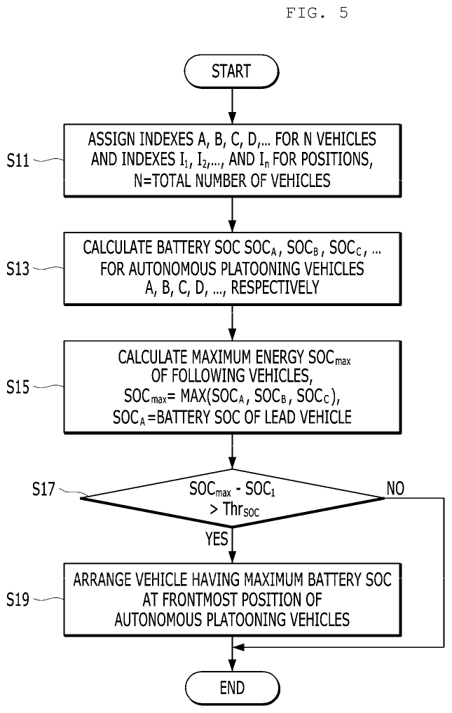

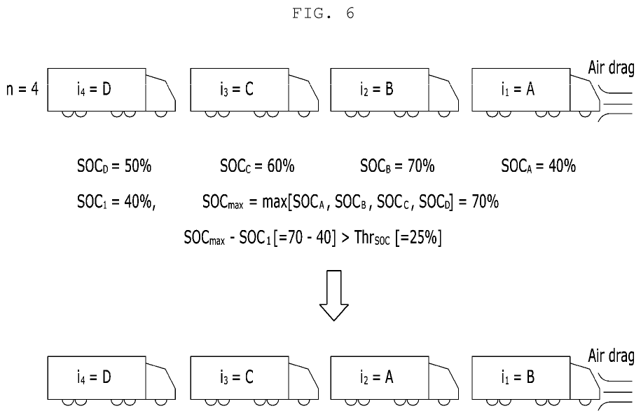

FIG. 5 is a flowchart for explanation of a method of controlling autonomous platooning in some forms of the present disclosure. FIG. 6 is a diagram for explanation of a vehicle rearrangement procedure of the method of controlling autonomous platooning of FIG. 5.

As shown in FIGS. 5 and 6, a method of controlling autonomous platooning in some forms of the present disclosure is a strategic method of balancing a battery SoC between vehicles for exchanging positions of a lead vehicle and one of following vehicles.

First, in some forms of the present disclosure, when an autonomous platooning control request signal is received, an index may be assigned to each autonomous platooning vehicle (S11).

Here, in some forms of the present disclosure, when the index is assigned, the total number of all autonomous platooning vehicles may be recognized, and indexes may be assigned to respective vehicles and respective positions from all of the recognized vehicles.

For example, in some forms of the present disclosure, when an index is assigned, a first index may be assigned to each of all of the autonomous platooning vehicles, and a second index corresponding to a position may be assigned to each vehicle to which the first index is assigned.

That is, in some forms of the present disclosure, when the total number of all the autonomous platooning vehicles is n, the respective first indexes A, B, C, D, . . . may be assigned to the n vehicles and second indexes i₁, i₂, . . . , and iₙ may be assigned to respective positions.

As shown in FIG. 6, when the total number of all autonomous platooning vehicles is 4, first indexes A, B, C, and D may be assigned to the respective vehicles, and the second indexes i₁, i₂, i₃, and i₄ may be assigned to respective positions of the vehicles to which the first index is assigned.

For example, a driving arrangement order in which vehicle A is at position i₁, vehicle B is at position i₂, vehicle C is at position i₃, and vehicle D is at position i₄ may be achieved.

Then, in some forms the present disclosure, battery information may be acquired from a vehicle to which an index is assigned, and respective battery SoC values of the autonomous platooning vehicles may be calculated based on the acquired battery information (S13).

That is, in some forms the present disclosure, battery SoC values SoC_{A}, SoC_{B}, SoC_{C}, . . . may be calculated for the autonomous platooning vehicles A, B, C, D, . . . , respectively.

For example, as shown in FIG. 6, in some forms of the present disclosure, battery SoC_{A} of vehicle A, battery SoC_{B} of vehicle B, battery SoC_{C} of vehicle C, and battery SoC_{D} of vehicle D may each be calculated.

Then, in some forms of the present disclosure, a difference value between a first battery SoC value of a following vehicle having a maximum battery SoC value and a second battery SoC value of a lead vehicle among the autonomous platooning vehicles may be calculated (S15).

That is, in some forms of the present disclosure, a difference value between the maximum energy SoCₘₐₓ of the following vehicles and battery SoC₁ of the lead vehicle may be calculated.

For example, as shown in FIG. 6, when battery SoC_{A} of vehicle A is about 40%, battery SoC_{B} of vehicle B is about 70%, battery SoC_{C} of vehicle C is about 60%, and battery SoC_{D} of vehicle D is about 50%, battery SoC₁ of the lead vehicle may be about 40% and the maximum energy SoCₘₐₓ of the following vehicles may be about 70%.

i.e., SoCₘₐₓ=max(SoC_{A}, SoC_{B}, SoC_{C}, SoC_{D})=70%

Accordingly, a difference value between maximum energy SoCₘₐₓ of the following vehicles and battery SoC₁ of the lead vehicle may be about 30%.

i.e., SOCₘₐₓ−SOC1=70%−40%=30%

Then, in some forms of the present disclosure, whether the calculated difference value is greater than a threshold value may be checked (S17).

For example, as shown in FIG. 6, when the difference value between the maximum energy SoCₘₐₓ of the following vehicles and battery SoC₁ of the lead vehicle is about 30% and the threshold value is about 25%, it may be seen that the calculated difference value is greater than the threshold value.

i.e., SOCₘₐₓ−SoC₁>Thr_{SOC}

Then, in some forms of the present disclosure, when the calculated difference value is greater than the threshold value, a driving arrangement order may be determined to arrange a following vehicle having a maximum battery SoC value at a frontmost position of the group, and the vehicles may be controlled to rearrange the autonomous platooning vehicles according to the determined driving arrangement order (S19).

For example, as shown in FIG. 6, the autonomous platooning vehicles may be rearranged according to the determined driving arrangement order in which vehicle B is at position i₁, vehicle A is at position i₂, vehicle C is at position i₃, and vehicle D is at position i₄ from the original driving arrangement order in which vehicle A is at position i₁, vehicle B is at position i₂, vehicle C is at position i₃, and vehicle D is at position i₄.

As such, some forms of the present disclosure correspond to a strategic method of balancing a battery SoC between vehicles, in which case battery SoC information of each EV may be acquired, a vehicle having the highest battery SoC may be positioned at a frontmost position of the group, which increases a battery SoC consumption rate of the lead vehicle, and then an SoC of a vehicle having the highest battery SoC among the following vehicles and an SoC of the lead vehicle may be compared with each other, and when a difference value therebetween is equal to or greater than a specific value, the corresponding vehicle may be moved to the frontmost position of the group.

That is, some forms of the present disclosure correspond to a method for exchanging positions of a lead vehicle and one of following vehicles.

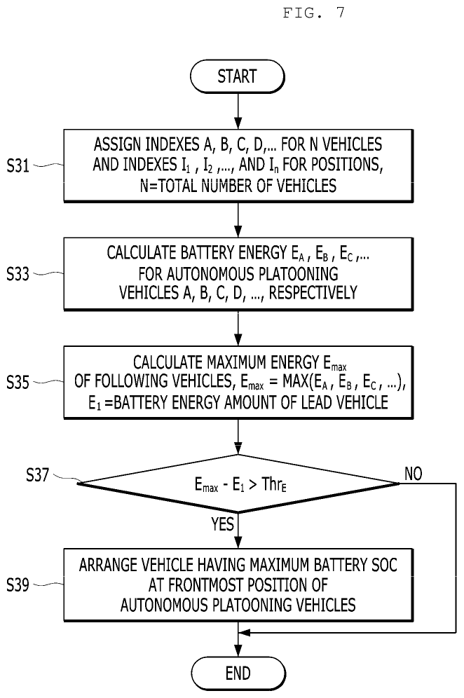

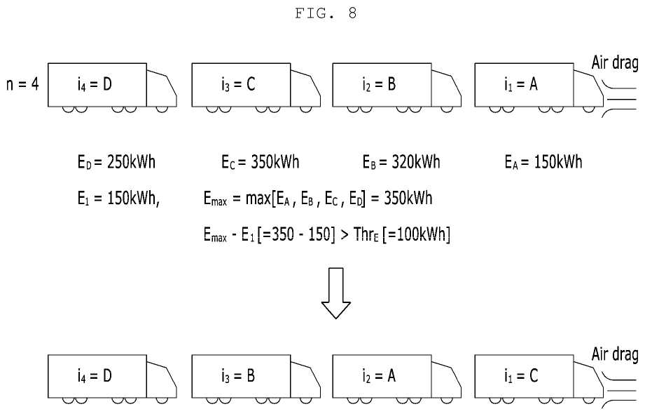

FIG. 7 is a flowchart for explanation of a method of controlling autonomous platooning in some forms of the present disclosure. FIG. 8 is a diagram for explanation of a vehicle rearrangement procedure of the method of controlling autonomous platooning of FIG. 7.

As shown in FIGS. 7 and 8, a method of controlling autonomous platooning in some forms of the present disclosure is a strategic method of balancing battery energy between vehicles for exchanging positions of a lead vehicle and one of following vehicles.

First, in some forms of the present disclosure, when an autonomous platooning control request signal is received, an index may be assigned to each autonomous platooning vehicle (S31).

Here, in some forms of the present disclosure, when the index is assigned, the total number of all autonomous platooning vehicles may be recognized, and indexes may be assigned to respective vehicles and respective positions from all of the recognized vehicles.

For example, in some forms of the present disclosure, when an index is assigned, a first index may be assigned to each of all of the autonomous platooning vehicles, and a second index corresponding to a position may be assigned to each vehicle to which the first index is assigned.

That is, in some forms of the present disclosure, when the total number of all autonomous platooning vehicles is n, the respective first indexes A, B, C, D, . . . may be assigned to the n vehicles and second indexes i₁, i₂, . . . , and iₙ may be assigned to respective positions.

As shown in FIG. 8, when the total number of all autonomous platooning vehicles is 4, the respective first indexes A, B, C, and D may be assigned to the vehicles, and the second indexes i₁, i₂, i₃, and i₄ may be assigned to respective positions for each vehicle to which the first index is assigned.

For example, a driving arrangement order in which vehicle A is at position i₁, vehicle B is at position i₂, vehicle C is at position i₃, and vehicle D is at position i₄ may be achieved.

Then, in some forms of the present disclosure, battery information may be acquired from a vehicle to which an index is assigned, and respective battery energy amounts of the autonomous platooning vehicles may be calculated based on the acquired battery information (S33).

That is, in some forms of the present disclosure, battery energy amounts E_{A}, E_{B}, E_{C}, . . . may be calculated for the autonomous platooning vehicles A, B, C, D, . . . , respectively.

For example, as shown in FIG. 8, in some forms of the present disclosure, battery energy amount E_{A} of vehicle A, battery energy amount E_{B} of vehicle B, battery energy amount E_{C} of vehicle C, and battery energy amount E_{D} of vehicle D may each be calculated.

Then, in some forms of the present disclosure, a difference value between a first battery energy amount of a following vehicle having a maximum battery energy amount and a second battery energy amount of a lead vehicle among the autonomous platooning vehicles may be calculated (S35).

That is, in some forms of the present disclosure, a difference value between the maximum energy amount Eₘₐₓ of the following vehicles and battery energy amount E₁ of the lead vehicle may be calculated.

For example, as shown in FIG. 8, when battery energy amount E_{A} of vehicle A is about 150 kWh, battery energy amount E_{B} of vehicle B is about 320 kWh, battery energy amount E_{C} of vehicle C is about 350 kWh, and battery energy amount E_{D} of vehicle D is about 250 kWh, battery E₁ of the lead vehicle may be about 150 kWh and the maximum energy Eₘₐₓ of the following vehicles may be about 350 kWh.

i.e., Eₘₐₓ=max(E_{A}, E_{B}, E_{C}, E_{D})=350 kWh

Accordingly, a difference value between maximum energy amount Eₘₐₓ of the following vehicles and battery energy amount E₁ of the lead vehicle may be about 200 kWh.

i.e., Eₘₐₓ−E₁=350 kWh−150 kWh=200 kWh

Then, in some forms of the present disclosure, whether the calculated difference value is greater than a threshold value may be checked (S37).

For example, as shown in FIG. 8, when the difference value between the maximum energy amount Eₘₐₓ of the following vehicles and battery energy amount E₁ of the lead vehicle is about 200 kWh and the threshold value is about 100 kWh, it may be seen that the calculated difference value is greater than the threshold value.

i.e., Eₘₐₓ−E₁>Thr_{E}

Then, in some forms of the present disclosure, when the calculated difference value is greater than the threshold value, a driving arrangement order may be determined to arrange a following vehicle having a maximum battery energy amount at a frontmost position of the group, and the vehicles may be controlled to rearrange the autonomous platooning vehicles according to the determined driving arrangement order (S39).

For example, as shown in FIG. 8, the autonomous platooning vehicles may be rearranged according to the determined driving arrangement order in which vehicle C is at position i₁, vehicle A is at position i₂, vehicle B is at position i₃, and vehicle D is at position i₄ from the original driving arrangement order in which vehicle A is at position i₁, vehicle B is at position i₂, vehicle C is at position i₃, and vehicle D is at position i₄.

As such, some forms of the present disclosure correspond to a strategic method of balancing battery energy balancing between vehicles, in which case battery energy information of each EV may be acquired, a vehicle having the highest battery energy may be positioned at a frontmost position of the group, which increases battery output of the lead vehicle, and then battery energy of a vehicle having the highest battery energy among the following vehicles and battery energy of the lead vehicle may be compared with each other, and when a difference value therebetween is equal to or greater than a specific value, the corresponding vehicle may be moved to the frontmost position of the group.

That is, some forms of the present disclosure correspond to a method for exchanging positions of a lead vehicle and one of following vehicles.

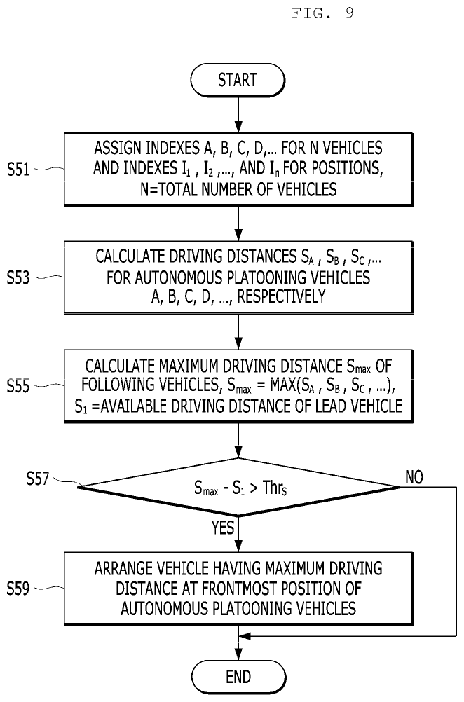

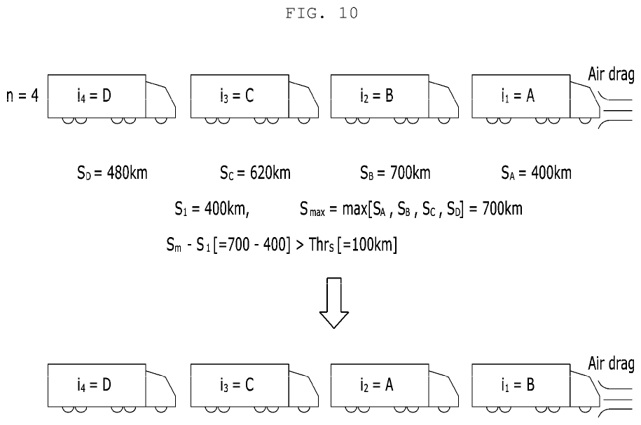

FIG. 9 is a flowchart for explanation of a method of controlling autonomous platooning in some forms of the present disclosure. FIG. 10 is a diagram for explanation of a vehicle rearrangement procedure of the method of controlling autonomous platooning of FIG. 9.

As shown in FIGS. 9 and 10, a method of controlling autonomous platooning in some forms of the present disclosure is a strategic method of increasing a platooning distance for exchanging positions of a lead vehicle and one of following vehicles.

First, in some forms of the present disclosure, when an autonomous platooning control request signal is received, an index may be assigned to each autonomous platooning vehicle (S51).

Here, in some forms of the present disclosure, when the index is assigned, the total number of all autonomous platooning vehicles may be recognized, and indexes may be assigned to respective vehicles and respective positions from all of the recognized vehicles.

For example, in some forms of the present disclosure, when an index is assigned, a first index may be assigned to each of all of the autonomous platooning vehicles, and a second index corresponding to a position may be assigned to each vehicle to which the first index is assigned.

That is, in some forms of the present disclosure, when the total number of all autonomous platooning vehicles is n, the respective first indexes A, B, C, D, . . . may be assigned to the n vehicles and second indexes i₁, i₂, . . . , and iₙ may be assigned to respective positions.

As shown in FIG. 10, when the total number of all autonomous platooning vehicles is 4, the first indexes A, B, C, and D may be assigned to the respective vehicles, and the second indexes i₁, i₂, i₃, and i₄ may be assigned to positions of the vehicles to which the first index is assigned.

For example, a driving arrangement order in which vehicle A is at position i₁, vehicle B is at position i₂, vehicle C is at position i₃, and vehicle D is at position i₄ may be achieved.

Then, in some forms of the present disclosure, battery information and vehicle information may be acquired from a vehicle to which an index is assigned, and respective driving distances of the autonomous platooning vehicles may be estimated based on the acquired battery information and vehicle information (S53).

Here, the battery information may be a battery energy amount, and the vehicle information may include at least one of battery capacity, a battery deterioration degree, and a battery SoC of the vehicle to which the index is assigned, the weight of the vehicle to which the index is assigned, air resistance force, a slope, or drag but is not limited thereto.

That is, in some forms of the present disclosure, driving distances S_{A}, S_{B}, S_{C}, . . . may be calculated for the autonomous platooning vehicles A, B, C, D, . . . , respectively.

For example, as shown in FIG. 10, in some forms of the present disclosure, driving distance S_{A} of vehicle A, driving distance S_{B} of vehicle B, driving distance S_{C} of vehicle C, and driving distance S_{D} of vehicle D may each be calculated.

Then, in some forms of the present disclosure, a difference value between a first driving distance of a following vehicle having a maximum driving distance and a second driving distance of a lead vehicle among the autonomous platooning vehicles may be calculated (S55).

That is, in some forms of the present disclosure, a difference value between the maximum driving distance Sₘₐₓ of the following vehicles and driving distance S₁ of the lead vehicle may be calculated.

For example, as shown in FIG. 10, when driving distance S_{A} of vehicle A is about 400 km, driving distance S_{B} of vehicle B is about 700 km, driving distance S_{C} of vehicle C is about 620 km, and driving distance S_{D} of vehicle D is about 480 km, driving distance S₁ of the lead vehicle may be about 400 km and the maximum driving distance Sₘₐₓ of the following vehicles may be about 700 km.

i.e., Sₘₐₓ=max(S_{A}, S_{B}, S_{C}, S_{D})=700 km

Accordingly, a difference value between maximum driving distance Sₘₐₓ of the following vehicles and driving distance S₁ of the lead vehicle may be about 300 km.

i.e., Sₘₐₓ−S₁=700 km−400 km=300 km

Then, in some forms of the present disclosure, whether the calculated difference value is greater than a threshold value may be checked (S57).

For example, as shown in FIG. 10, when the difference value between the maximum driving distance Sₘₐₓ of the following vehicles and driving distance S₁ of the lead vehicle is about 300 km and the threshold value is about 100 km, it may be seen that the calculated difference value is greater than the threshold value.

i.e., Sₘₐₓ−S₁>Thr_{S}

Then, in some forms of the present disclosure, when the calculated difference value is greater than the threshold value, a driving arrangement order may be determined to arrange a following vehicle having a maximum driving distance at a frontmost position of the group, and the vehicles may be controlled to rearrange the autonomous platooning vehicles according to the determined driving arrangement order (S39).

For example, as shown in FIG. 10, the autonomous platooning vehicles may be rearranged according to the determined driving arrangement order in which vehicle B is at position i₁, vehicle A is at position i₂, vehicle C is at position i₃, and vehicle D is at position i₄ from the original driving arrangement order in which vehicle A is at position i₁, vehicle B is at position i₂, vehicle C is at position i₃, and vehicle D is at position i₄

As such, some forms of the present disclosure correspond to a strategic method of increasing a platooning distance, in which case an available driving distance may be estimated in consideration of a current battery energy amount and vehicle information of each vehicle, a vehicle having the highest available driving distance may be positioned at a frontmost position of the group, and then an available driving distance of a vehicle having the highest available driving distance among the following vehicles and an available driving distance of the lead vehicle may be compared with each other, and when a difference value therebetween is equal to or greater than a specific value, the corresponding vehicle may be moved to the frontmost position of the group.

That is, some forms of the present disclosure correspond to a method for exchanging positions of a lead vehicle and one of following vehicles.

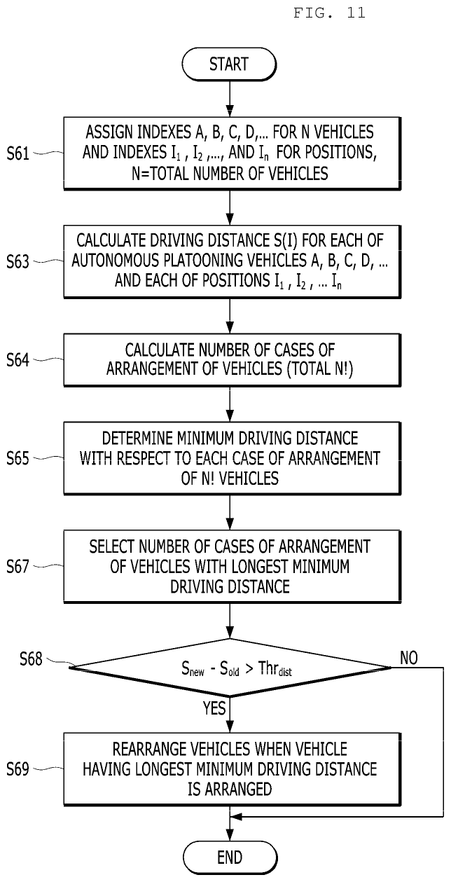

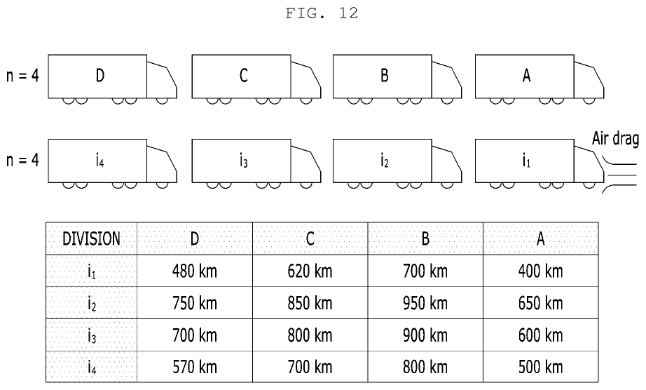

FIG. 11 is a flowchart for explanation of a method of controlling autonomous platooning in some forms of the present disclosure. FIGS. 12 to 16 are diagrams for explanation of a vehicle rearrangement procedure of the method of controlling autonomous platooning of FIG. 11.

As shown in FIGS. 11 to 16, a method of controlling autonomous platooning in some forms of the present disclosure is a strategic method of maximizing a platooning distance for changing a position of all vehicles for maximizing a driving distance.

First, in some forms of the present disclosure, when an autonomous platooning control request signal is received, an index may be assigned to each autonomous platooning vehicle (S61).

Here, in some forms of the present disclosure, when the index is assigned, the total number of all autonomous platooning vehicles may be recognized, and indexes may be assigned to respective vehicles and respective positions from all of the recognized vehicles.

For example, in some forms of the present disclosure, when an index is assigned, a first index may be assigned to each of all of the autonomous platooning vehicles, and a second index corresponding to a position may be assigned to each vehicle to which the first index is assigned.

That is, in some forms of the present disclosure, when the total number of all autonomous platooning vehicles is n, first indexes A, B, C, D, . . . may be assigned to the n vehicles and the second indexes i₁, i₂, . . . , and iₙ may be assigned to respective positions.

As shown in FIG. 12, when the total number of all autonomous platooning vehicles is 4, the first indexes A, B, C, and D may be assigned to the respective vehicles, and the second indexes i₁, i₂, i₃, and i₄ may be assigned to positions of the vehicles to which the first index is assigned.

For example, a driving arrangement order in which vehicle A is at any one of positions i₁, i₂, i₃, and i₄, vehicle B is at any one of positions i₁, i₂, i₃, and i₄, vehicle C is at any one of positions i₁, i₂, i₃, and i₄, and vehicle D is at any one of positions i₁, i₂, i₃, and i₄ may be achieved.

Then, in some forms of the present disclosure, battery information and vehicle information may be acquired from a vehicle to which an index is assigned, and respective driving distances of the autonomous platooning vehicles may be estimated based on the acquired battery information and vehicle information (S63).

Here, an autonomous platooning vehicle encounters different air resistances depending on a current position during platooning, and thus may have different available driving distances, thereby estimating available driving distances for respective positions.

For example, the battery information may be a battery energy amount, and the vehicle information may include at least one of battery capacity, a battery deterioration degree, and a battery SoC of the vehicle to which the index is assigned, the weight of the vehicle to which the index is assigned, air resistance force, a slope, or drag, but is not limited thereto.

That is, in some forms of the present disclosure, a driving distance S(i) may be calculated for each of the autonomous platooning vehicles A, B, C, D, . . . and each of the positions i₁, i₂, i₃, and i₄.

For example, as shown in FIG. 12, in some forms of the present disclosure, driving distances S_{A}(i₁), S_{A}(i₂), S_{A}(i₃), S_{A}(i₄) of vehicle A, driving distances S_{B}(i₁), S_{B}(i₂), S_{B}(i₃), and S_{B}(i₄) of vehicle B, driving distances S_{C}(i₁), S_{C}(i₂), S_{C}(i₃), and S_{C}(i₄) of vehicle C, and driving distances S_{D}(i₁), S_{D}(i₂), S_{D}(i₃), and S_{D}(i₄) of vehicle D may each be calculated.

Then, in some forms of the present disclosure, the number of cases of arrangement of platooning vehicles may be calculated based on the estimated driving distance (S64).

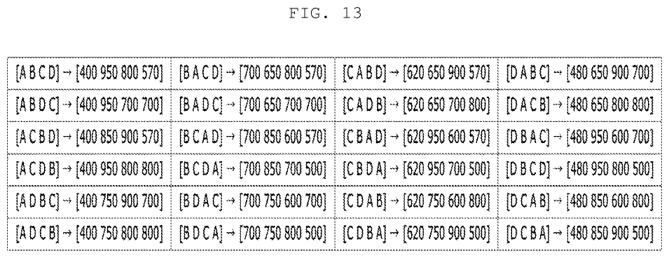

For example, as shown in FIG. 13, when the total number of all autonomous platooning vehicles is 4, the total number of cases of 4! may be calculated.

Here, each case of arrangement of platooning vehicles may include a driving arrangement order of autonomous platooning vehicles and a driving distance of each vehicle.

Then, in some forms of the present disclosure, a minimum driving distance may be determined for each case of arrangement of platooning vehicles (S65).

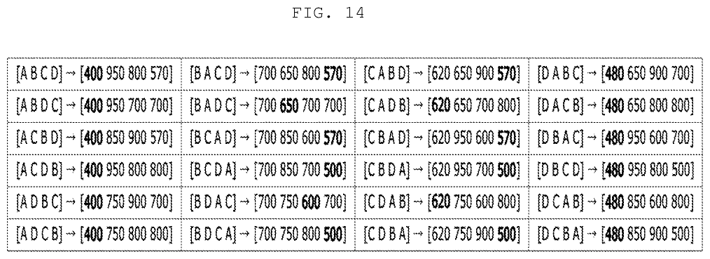

For example, as shown in FIG. 14, among the cases of arrangement of platooning vehicles, in the case in which a driving arrangement order is A, B, C, and D and driving distances of the respective vehicles are 400, 950, 800, and 570, a minimum driving distance may be determined to be 400.

In some forms of the present disclosure, a case having the longest minimum driving distance among cases having the determined minimum driving distances may be selected as a new case (S67).

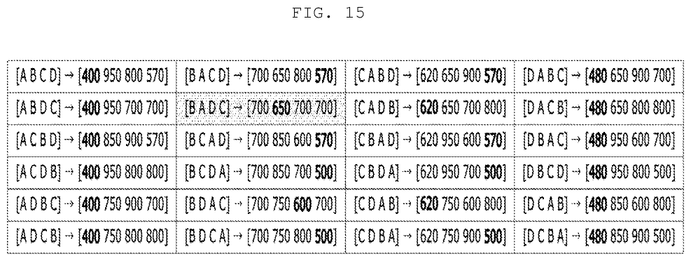

For example, as shown in FIG. 15, among the cases of arrangement of platooning vehicles, in the case in which a driving arrangement order is B, A, D, and C and driving distances of the respective vehicles are 700, 650, 700, and 700, a minimum driving distance may be determined to be 650, and thus, the corresponding case may be determined to be the case having the longest minimum driving distance among minimum driving distances of the all cases.

Then, in some forms of the present disclosure, whether a difference value between a maximum driving distance S_{new} in the new case and a maximum driving distance S_{old} of a current case is greater than a threshold value may be checked (S68).

i.e., S_{new}−S_{old}>Thr_{dist}

Then, in some forms of the present disclosure, when the calculated difference value is greater than the threshold value, a driving arrangement order may be determined according to arrangement of platooning vehicles corresponding to the new case, and vehicles may be controlled to rearrange the autonomous platooning vehicles according to the determined driving arrangement order (S69).

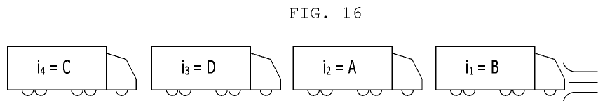

For example, as shown in FIG. 16, the autonomous platooning vehicles may be rearranged according to the determined driving arrangement order in which vehicle B is at position i₁, vehicle A is at position i₂, vehicle D is at position i₃, and vehicle C is at position i₄ from the original driving arrangement order in which vehicle A is at position i₁, vehicle B is at position i₂, vehicle C is at position i₃, and vehicle D is at position i₄.

A procedure of maximizing a platooning distance in some forms of the present disclosure will be mathematized below.

maxₖ{min[S₁(i₁), S₂(i₂), S₃(i₃), S₄(i₄), . . . , Sₙ(iₙ)]ₖ}

k=1, . . . , n!

i₁, i₂, i₃, . . . , iₙ∈{a, b, c, d, . . . .}

Here, i₁ is a primarily positioned vehicle and corresponds to arrangement of one of vehicle IDs A, B, C, D, . . . and i₃ is a tertiarily positioned vehicle and corresponds to arrangement of one of the remaining vehicles other than vehicles arranged at i₁ and i₂.

i.e., i₃∈{A, B, C, D, . . . }−{i₁, i₂}

iₙ is a vehicle at an n^{th} position and corresponds to arrangement of the remaining vehicles except for vehicles arranged at i₁, i₂, . . . , and iₙ₋₁.

i.e., iₙ∈{A, B, C, D, . . . }−{i₁, i₂, . . . , iₙ₋₁}

S₁(i₁) is an available driving distance of a primarily positioned vehicle i₁, and S₂(i₂) is an available driving distance of a secondarily positioned vehicle i₂.

As such, some forms of the present disclosure is a strategic method of maximizing a platooning distance, in which case indexes may be assigned with respect to all vehicles and an arrangement order of all vehicles, and an available driving distance may be estimated in consideration of a current battery energy amount and vehicle information of each vehicle.

Then, a maximum available driving distance in the group during platooning may be determined by a vehicle having the shortest available driving distance among the all vehicles, and thus in some forms of the present disclosure, in each case (total n!) of arrangement of platooning vehicles, a minimum value of a separate vehicle available driving distance may be calculated, and a case of arrangement of platooning vehicles with a maximized available driving distance of platooning may be selected according to arrangement of each vehicle, and when a newly calculated maximum available driving distance S_{new} of a platooning vehicle is greater than a maximum available driving distance S_{old} according to current vehicle arrangement by a specific value Thr_{dist} or greater, vehicles may be rearranged.

That is, some forms of the present disclosure is a method for changing a position of all vehicles for maximizing a driving distance.

As such, according to the present disclosure, an apparatus for controlling autonomous platooning of an electric vehicle including an index assignment unit, a driving arrangement order determination unit, and a controller may perform a method of controlling autonomous platooning as follows.

According to the present disclosure, when the index assignment unit receives an autonomous platooning control request signal, an index may be assigned to each autonomous platooning vehicle.

Here, the assigning the index may include recognizing the total number of all autonomous platooning vehicles, and assigning indexes to respective vehicles and respective positions from all of the recognized vehicles.

The assigning the index may include assigning a first index to each vehicle among all of the autonomous platooning vehicles and assigning a second index corresponding to a position to each vehicle to which the first index is assigned.

According to the present disclosure, the driving arrangement order determination unit may acquire battery information from the vehicle to which an index is assigned, and may determine a driving arrangement order of autonomous platooning vehicles based on the acquired battery information.

For example, in the determining the driving arrangement order, battery SoC values of autonomous platooning vehicles may be calculated based on the acquired battery information, and a driving arrangement order may be determined to arrange a vehicle having a maximum battery SoC value among the autonomous platooning vehicles at a frontmost position of the group.

Here, in the determining the driving arrangement order, a difference value between a first battery SoC value of a following vehicle having a maximum battery SoC value and a second battery SoC value of the lead vehicle among the autonomous platooning vehicles may be calculated, and whether the calculated difference value is greater than a threshold value may be checked, and when the calculated difference value is greater than the threshold value, the driving arrangement order may be determined to arrange the following vehicle having the maximum battery SoC value at a frontmost position of the group.

In another example, in the determining the driving arrangement order, battery energy amounts of autonomous platooning vehicles may be calculated based on the acquired battery information, and the driving arrangement order may be determined to arrange the vehicle having the maximum battery energy amount among the autonomous platooning vehicles at a frontmost position of the group.

Here, in the determining the driving arrangement order, a difference between a first battery energy amount of a following vehicle having a maximum battery energy amount and a second battery energy amount of a lead vehicle among the autonomous platooning vehicles may be calculated, and whether the calculated difference value is greater than a threshold value may be checked, and when the calculated difference value is greater than the threshold value, the driving arrangement order may be determined to arrange the following vehicle having the maximum battery energy amount at a frontmost position of the group.

In another example, in the determining the driving arrangement order, driving distances of the autonomous platooning vehicles may each be estimated based on the acquired battery information and vehicle information, and the driving arrangement order may be determined to arrange the vehicle having the maximum driving distance among the autonomous platooning vehicles at a frontmost position of the group.

Here, in the determining the driving arrangement order, a difference value between a first driving distance of a following vehicle having a maximum driving distance and a second driving distance of the lead vehicle among the autonomous platooning vehicles may be calculated, and whether the calculated difference value is greater than a threshold value may be checked, and when the calculated difference value is greater than the threshold value, the driving arrangement order may be determined to arrange the following vehicle having the maximum driving distance at a frontmost position of the group.

In another example, in the determining the driving arrangement order, driving distances of autonomous platooning vehicles may each be estimated based on the acquired battery information and vehicle information, the number of cases of arrangement of platooning vehicles may be calculated based on the estimated driving distances, a minimum driving distance in each case of arrangement of the platooning vehicles may be determined, a case having the longest minimum driving distance among cases having the determined minimum driving distances may be selected as a new case, and a driving arrangement order according to arrangement of platooning vehicles, which corresponds to the new case, may be determined.

Here, in the determining the driving arrangement order, driving distances of autonomous platooning vehicles may each be estimated based on the acquired battery information and vehicle information, the number of cases of arrangement of platooning vehicles may be calculated based on the estimated driving distance, minimum driving distances for the respective cases of arrangement of platooning vehicles may be determined, a case having the longest minimum driving distance among cases having the determined minimum driving distances may be selected as a new case, and whether a difference value between a maximum driving distance in the new case and a maximum driving distance in the current case is greater than a threshold value may be checked, and when the difference value is greater than the threshold value, a driving arrangement order may be determined according to arrangement of platooning vehicles, which corresponds to the new case.

Then, according to the present disclosure, the controller may control vehicles to rearrange the autonomous platooning vehicles according to the determined driving arrangement order.

As such, according to the present disclosure, battery information and vehicle information may be acquired from the autonomous platooning vehicles, the driving arrangement order may be determined based on the acquired battery information and vehicle information, and the autonomous platooning vehicles may be rearranged according to the determined driving arrangement order, thereby maximizing driving distance of the entire group.

In addition, according to the present disclosure, a computer readable recording medium having recorded thereon a program for executing the method of controlling autonomous platooning of the apparatus for controlling autonomous platooning of an electric vehicle may perform procedures provided by the autonomous platooning control method.

An apparatus and method of controlling autonomous platooning of an electric vehicle related to at least one form of the present disclosure may acquire battery information and vehicle information from autonomous platooning vehicles, may determine a driving arrangement order based on the acquired information, and may rearrange the autonomous platooning vehicles according to the determined driving arrangement order, thereby maximizing a driving distance of the entire group.

That is, the present disclosure may be based on fully autonomous driving technology for enlarging proliferation of an electric vehicle (EV) and for V2V communication between vehicles.

The core technology according to the present disclosure may be control technology for estimating the battery energy or available driving distance of autonomous platooning electric vehicles and changing a driving order based on the estimated battery energy or available driving distance to maximize a driving distance of the entire group.

It will be appreciated by persons skilled in the art that that the effects that could be achieved with the present disclosure are not limited to what has been particularly described hereinabove and other advantages of the present disclosure will be more clearly understood from the detailed description.

The aforementioned present disclosure can also be embodied as computer readable code stored on a computer readable recording medium. The computer readable recording medium is any data storage device that can store data which can thereafter be read by a computer. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An apparatus for controlling autonomous platooning of an electric vehicle, comprising:
a communication unit configured to communicate with a plurality of autonomous platooning vehicles;
an index assignment unit configured to assign indexes to each autonomous platooning vehicle of the plurality of autonomous platooning vehicles;
a driving arrangement order determination unit configured to:
acquire battery information from the autonomous platooning vehicles of the plurality of autonomous platooning vehicles through the communication unit; and
determine a driving arrangement order of the assigned autonomous platooning vehicles based on the acquired battery information; and
a controller configured to:
rearrange the autonomous platooning vehicles of the plurality of autonomous platooning vehicles based on the determined driving arrangement order.

2. The apparatus of claim 1, wherein, when assigning the indexes, the index assignment unit is configured to:
recognize a total number of the plurality of autonomous platooning vehicles; and
assign the indexes and positions to each autonomous platooning vehicles of the plurality of autonomous platooning vehicles based on the total number of the plurality of autonomous platooning vehicles.

3. The apparatus of claim 1, wherein, when assigning the indexes, the index assignment unit is configured to:
assign a first index to each autonomous platooning vehicle of the plurality of autonomous platooning vehicles; and
assign a second index corresponding to a position to each autonomous platooning vehicle of the plurality of autonomous platooning vehicles.

4. The apparatus of claim 1, wherein, when acquiring the battery information, the driving arrangement order determination unit is configured to:
acquire the battery information including at least one of battery state-of-charge (SoC) information or battery energy amount information.

5. The apparatus of claim 1, wherein, when acquiring the battery information, the driving arrangement order determination unit is further configured to acquire vehicle information.

6. The apparatus of claim 1, wherein, when determining the driving arrangement order of the autonomous platooning vehicle, the driving arrangement order determination unit is configured to:
calculate battery SoC values of the plurality of autonomous platooning vehicles based on the acquired battery information; and
place an autonomous platooning vehicle having a maximum battery SoC value among the plurality of autonomous platooning vehicles at a front most position of the plurality of autonomous platooning vehicles.

7. The apparatus of claim 1, wherein, when determining the driving arrangement order of the autonomous platooning vehicle, the driving arrangement order determination unit is configured to:
calculate battery energy amounts of the plurality of autonomous platooning vehicles based on the acquired battery information; and
place an autonomous platooning vehicle having a maximum battery energy amount at a frontmost position of the plurality of autonomous platooning vehicles.

8. The apparatus of claim 1, wherein, when determining the driving arrangement order of the autonomous platooning vehicles, the driving arrangement order determination unit is configured to:
estimate driving distances of each autonomous platooning vehicle of the plurality of autonomous platooning vehicles based on the acquired battery information and vehicle information; and
place an autonomous platooning vehicle having a maximum driving distance at the frontmost position of the plurality of autonomous platooning vehicles.

9. The apparatus of claim 1, wherein, when determining the driving arrangement order of the autonomous platooning vehicle, the driving arrangement order determination unit is configured to:
estimate the driving distances of each autonomous platooning vehicle of the plurality of autonomous platooning vehicles based on the acquired battery information and the vehicle information;
calculate a number of cases of arrangement of the plurality of autonomous platooning vehicles based on the estimated driving distances;
determine a minimum driving distance in each case of arrangement of the plurality of autonomous platooning vehicles;
select a case having a longest minimum driving distance as a new case;
check whether a difference value between a maximum driving distance in the new case and a maximum driving distance in a current case is greater than a threshold value; and
when the difference value is greater than the threshold value, determine the driving arrangement order based on the arrangement of the plurality of autonomous platooning vehicles corresponding to the new case.

10. The apparatus of claim 9, wherein each case of an arrangement of the plurality of autonomous platooning vehicles comprises:
a driving arrangement order of the plurality of autonomous platooning vehicles; and
a driving distance of the plurality of autonomous platooning vehicles.

11. A method for controlling autonomous platooning of an electric vehicle, comprising:
when an autonomous platooning control request signal is received, assigning, by an index assignment unit, indexes to each autonomous platooning vehicle of a plurality of autonomous platooning vehicles;
acquiring, by a driving arrangement order determination unit, battery information from the assigned autonomous platooning vehicles;
determining, by the driving arrangement order determination unit, a driving arrangement order of the assigned autonomous platooning vehicles based on the acquired battery information; and
rearranging, by a controller, the autonomous platooning vehicles of the plurality of autonomous platooning vehicles based on the determined driving arrangement order.

12. The method of claim 11, wherein assigning the indexes comprises:
recognizing, by the index assignment unit, a total number of autonomous platooning vehicles of the plurality of autonomous platooning vehicles; and
assigning, by the index assignment unit, the indexes and positions to each autonomous platooning vehicle of the plurality of autonomous platooning vehicles based on the total number of the plurality of autonomous platooning vehicles.

13. The method of claim 11, wherein determining the driving arrangement order comprises:
acquiring, by the driving arrangement order determination unit, the battery information including at least one of battery state-of-charge (SoC) information or battery energy amount information.

14. The method of claim 11, wherein determining the driving arrangement order comprises:
acquiring, by the driving arrangement order determination unit, vehicle information.

15. The method of claim 11, wherein determining the driving arrangement order comprises:
calculating battery SoC values of the plurality of autonomous platooning vehicles based on the acquired battery information; and
placing an autonomous platooning vehicle having a maximum battery SoC value among the plurality of autonomous platooning vehicles at a frontmost position of the plurality of autonomous platooning vehicles.

16. The method of claim 11, wherein determining the driving arrangement order comprises:
calculating battery energy amounts of the plurality of autonomous platooning vehicles based on the acquired battery information; and
placing an autonomous platooning vehicle having a maximum battery energy amount at the frontmost position of the plurality of autonomous platooning vehicles.

17. The method of claim 11, wherein determining the driving arrangement order comprises:
estimating driving distances of the plurality of autonomous platooning vehicles based on the acquired battery information and vehicle information; and
placing an autonomous platooning vehicle having a maximum driving distance at the frontmost position of the plurality of autonomous platooning vehicles.

18. The method of claim 11, wherein determining the driving arrangement order comprises:
estimating the driving distances of the plurality of autonomous platooning vehicles based on the acquired battery information and the vehicle information;
calculating a number of cases of arrangement of the plurality of autonomous platooning vehicles based on the estimated driving distances;
determining a minimum driving distance in each case of arrangement of the plurality of autonomous platooning vehicles;
selecting a case having a longest minimum driving distance as a new case;
checking whether a difference value between a maximum driving distance in the new case and a maximum driving distance in a current case is greater than a threshold value; and
when the difference value is greater than the threshold value, determining the driving arrangement order based on the arrangement of the plurality of autonomous platooning vehicles corresponding to the new case.

19. A server for controlling autonomous platooning of an electric vehicle, comprising:
a database configured to store battery information and vehicle information of a plurality of autonomous platooning vehicles; and
an autonomous platooning control apparatus configured to:
determine a driving arrangement order of autonomous platooning vehicles of the plurality of autonomous platooning vehicles based on the battery information and the vehicle information; and
rearrange the autonomous platooning vehicles of the plurality of autonomous platooning vehicles based on the determined driving arrangement order,
wherein the autonomous platooning control apparatus comprises:
a communication unit configured to communicate with the plurality of autonomous platooning vehicles;
an index assignment unit configured to assign indexes to the autonomous platooning vehicles of the plurality of autonomous platooning vehicles;
a driving arrangement order determination unit configured to:
acquire battery information from the assigned autonomous platooning vehicles through the communication unit; and
determine a driving arrangement order of the assigned autonomous platooning vehicles based on the acquired battery information; and
a controller configured to rearrange the plurality of autonomous platooning vehicles based on the determined driving arrangement order.

20. An electric vehicle comprising:
a storage configured to store battery information and vehicle information of a plurality of autonomous platooning vehicles; and
an autonomous platooning control apparatus configured to:
determine a driving arrangement order of the plurality of autonomous platooning vehicles based on the battery information and the vehicle information; and
rearrange the plurality of autonomous platooning vehicles based on the determined driving arrangement order, wherein the autonomous platooning control apparatus comprises:
a communication unit configured to communicate with the plurality of autonomous platooning vehicles;
an index assignment unit configured to assign indexes to the plurality of autonomous platooning vehicles;
a driving arrangement order determination unit configured to:
acquire battery information from the assigned autonomous platooning vehicles through the communication unit; and
determine a driving arrangement order of the assigned autonomous platooning vehicles based on the acquired battery information; and
a controller configured to rearrange the plurality of autonomous platooning vehicles based on the determined driving arrangement order.
